(19) United States
(12) Patent Application Publication
(10) Pub. No.: US 2024/0426322 A1
(43) Pub. Date: Dec. 26, 2024

(54) HAND-HELD PULLING AND COMPRESSION DEVICE AND HYDRAULIC FORCE AMPLIFIER

(71) Applicant: TKR Spezialwerkzeuge GmbH, Gevelsberg (DE)

(72) Inventor: Torsten KREISCHER, Wetter (DE)

(21) Appl. No.: 18/752,751

(22) Filed: Jun. 24, 2024

(30) Foreign Application Priority Data
Jun. 26, 2023 (DE) 10 2023 116 739.1

(51) Int. Cl. F15B 3/00; B21J 15/20; B21J 15/26

(52) U.S. Cl. CPC F15B 3/00; B21J 15/20; B21J 15/26

(57) ABSTRACT

The invention relates to a hand-held pulling and compression device and a hydraulic force amplifier for a hand-held pulling and compression device for driving pulling and pressing tools. In order to provide a hydraulic force amplifier for an electro-mechanically driven, hand-held pulling and compression device and a hand-held pulling and compression device which can be easily and flexibly adapted to different operations, it is provided that the hydraulic force amplifier has a housing body having at least one first working chamber filled with hydraulic fluid and having a connecting section for detachably fixing the hydraulic force amplifier to a connection section of the pulling and compression device. In addition, the hydraulic force amplifier has a first hydraulic piston which is arranged in the first working chamber so as to be displaceable between a starting position and an end position and which has a first piston surface and a coupling section for connection to a drive element of the pulling and compression device which is adjustable relative to the connection section. Furthermore, the hydraulic force amplifier has a second hydraulic piston which is displaceably arranged in the working chamber at a distance from the first hydraulic piston and has a second piston surface which is larger than the first piston surface and a mechanical tool connection for the pulling and pressing tool.

### CROSS-REFERENCE TO RELATED APPLICATION

This application is a convention priority application which claims priority to Germany patent application no. 10 2023 116 739.1, entitled “Hand-Held Pulling and Compression Device and Hydraulic Force Amplifier,” filed Jun. 26, 2023, the disclosure of which is incorporated herein by reference in its entirety.

### TECHNICAL FIELD

The invention relates to a hand-held pulling and compression device and a hydraulic force amplifier for a hand-held pulling and compression device for driving pulling and pressing tools.

### BACKGROUND

Hand-held pulling and compression devices, i.e. devices that can be used mobile by a person, such as hand-held, electric riveting and pressing devices for setting blind rivet elements, such as blind rivets and blind rivet nuts, or for carrying out punching processes and for setting punch rivets, which have a drive unit with an electric motor-driven threaded spindle of a screw drive, are known from the prior art in a variety of embodiments. The screw drive converts a rotational movement of the electric motor into a linear movement of the pulling and pressing tool in a known manner. In the case of the setting process of a blind rivet element, for example, a mandrel of the blind rivet element is moved axially.

The hand-held pulling and compression devices described above are used, for example, in vehicle workshops when carrying out repair work on the bodywork of vehicles and for maintenance work on tube or cable connections. Depending on the work to be carried out, it is necessary to use the pulling and compression devices to drive a large number of different interchangeable tools, for example with different forces.

Known hand-held devices that enable the operation of both pulling and pressing tools have the disadvantage that their application possibilities are limited by the design of the device, in particular the screw drive and/or the drive unit.

### SUMMARY

Based on this, the invention rests against the object of providing a hydraulic force amplifier for an electro-mechanically driven, hand-held pulling and compression device and a hand-held pulling and compression device which can be easily and flexibly adapted to different operations.

The invention solves the problem by a hydraulic force amplifier with the features of claim 1 and by a hand-held pulling and compression device with the features of claim 11. Advantageous further embodiments of the hydraulic force amplifier are given in claims 2 to 10.

The hydraulic force amplifier according to the invention (hereinafter referred to as force amplifier) has at least one housing body filled with hydraulic fluid, for example hydraulic oil, with a connecting section for detachable fixing of the force amplifier to a connection section of the pulling and compression device. According to the invention, the force amplifier has a first hydraulic piston arranged in the first working chamber so as to be displaceable between a starting position and an end position, with a first piston surface and a coupling section for connection to a drive element of the pulling and compression device that is adjustable relative to the connection section. In addition, according to the invention, the force amplifier has a second hydraulic piston arranged displaceably in the working chamber at a distance from the first hydraulic piston and having a second piston surface which is larger than the first piston surface and a mechanical tool connection for the pulling and pressing tool.

A hydraulic force amplifier is understood to be a unit that is designed to increase the tensile and compressive forces generated by the hand-held pulling and compression device and transmit them to a pulling or pressing tool.

The working chamber is delimited by an inner wall of the housing body and by the first piston surface of the first hydraulic piston and the second piston surface of the second hydraulic piston, which faces the first piston surface.

The design of the housing body with a connecting section makes it possible to fix the force amplifier to an electro-mechanically driven pulling and compression device so that it can be used for operations with higher tensile or compressive forces. The first hydraulic piston is reliably connected via its coupling section to a drive element that can be adjusted via the electro-mechanical drive, e.g. a tool holder of the pulling and compression device.

The fixed arrangement of the force amplifier on the pulling and compression device and the connection of the drive element of the pulling and compression device to the first hydraulic piston make it possible to reliably adjust the first hydraulic piston between its starting position and its end position, so that the second hydraulic piston is adjusted accordingly via the pressure generated in the working chamber. The second hydraulic piston can be adjusted between a starting state associated with the starting position and an end position state with the end position.

Due to the fact that the second piston surface is larger than the first piston surface, the force transmitted by the pulling and compression device to the first hydraulic piston is amplified. The second hydraulic piston can be mechanically connected to a pulling and pressing tool via the tool connection, for example via a positive fit in the longitudinal axis direction of the housing body, so that the amplified tensile and compressive forces are transmitted to the pulling and pressing tool. Switching between the use of tensile and compressive forces generated by the pulling and compression device and the tensile and compressive forces increased by the force amplifier can be carried out in a simple manner by disassembling and assembling the force amplifier.

In principle, the pressure of the hydraulic fluid is sufficient to transmit the tensile forces from the first hydraulic piston to the second hydraulic piston. According to an advantageous further development of the invention, it is provided that the second hydraulic piston is positively connected to the first hydraulic piston via a connecting element. The connecting element is, for example, detachably connected to the second hydraulic piston or integrally formed on the second hydraulic piston. The connecting element is designed in such a way that a positive fit is created between the first and the second hydraulic piston in the longitudinal axis direction of the housing body. In a preferred embodiment, the second hydraulic piston is connected to the first hydraulic piston via the connecting element in such a way that the positive fit is generated when the first hydraulic piston is adjusted from the end position in the direction of the starting position. Such a positive connection ensures easy adjustment of the second hydraulic piston by the first hydraulic piston both in the direction of the end position and in the direction of the starting position. The positive connection can be designed, for example, in the form of a thread or bayonet lock, so that both tensile and compressive forces of the drive element can be transmitted from the first hydraulic piston to the second hydraulic piston.

In a preferred embodiment, the first hydraulic piston has a receptacle for arranging the connecting element. The receptacle is understood to be a cavity of the first hydraulic piston. The receptacle extends with a cross-section, for example circular, in the longitudinal direction of the hydraulic piston. The cross-section of the receptacle is adapted to the shape of the connecting element in such a way that the connecting element can be adjusted within the receptacle when the hydraulic pistons are adjusted. Furthermore, the receptacle is sealed against the ingress of hydraulic fluid. The receptacle advantageously counteracts undesired mutual blocking of the hydraulic pistons when the hydraulic pistons move at different speeds.

A connection between the first hydraulic piston and the drive element of the pulling and compression device is essential for the function of the force amplifier. For the connection, a coupling element can be provided on the first hydraulic piston, for example, which can be connected to a drive element within the pulling or device. According to an advantageous further development of the invention, it is provided that the coupling section is designed for connection to a drive element of the pulling and compression device designed as a tool holder. The tool holder is usually a component arranged partially on the end face of the pulling and compression device and connected to the electro-mechanical drive, for example via a screw drive, which enables the pulling and pressing tools to be changed easily. The good accessibility required for this makes it particularly easy to connect the first hydraulic piston of the force amplifier to the tool holder, e.g. to bring it into contact. It is also possible to connect them in a form-fit manner so that the first hydraulic piston is positively connected to the tool holder in both adjustment directions of the hydraulic pistons.

In principle, the connection of the force amplifier to the pulling and compression device can be designed in any way. According to an advantageous embodiment of the invention, it is provided that the connecting section of the force amplifier has a thread or latching body for detachable fixing to the connection section of the pulling and compression device having a thread or latching body receptacles. A corresponding design of the connecting section enables a secure and easily detachable connection of the force amplifier to the pulling and compression device without the need for further components and/or securing elements. To release the connection between the force amplifier and the pulling and compression device, it is only necessary to unscrew it from the thread or to release the latching connection.

For example, the hydraulic pistons are arranged relative to one another in such a way that the hydraulic pistons can be adjusted along an axis, for example in the direction of the longitudinal axis of the housing body. According to an advantageous further development of the invention, however, it is provided that the hydraulic pistons can be arranged at an angle to one another. For example, the hydraulic pistons are arranged at an angle, for example between 70°-180°, preferably 75-180°, particularly preferably 80-180° to each other. The angle between the hydraulic pistons describes the angle between a longitudinal axis of the first hydraulic piston and a longitudinal axis of the second hydraulic piston. The housing body is designed such that the hydraulic pistons in the area mentioned above can be adjusted between different angular positions, for example 90°; 135° and 180°. Preferably, the housing body is made in at least two parts. In a preferred embodiment, the housing body has two housing parts that can be rotated relative to each other by an articulation element. The articulation element is arranged on the housing body in the area of the working chamber filled with hydraulic fluid, between the hydraulic pistons. Due to the flexible or fixed arrangement of the hydraulic pistons at an angle to each other, the advantageous design of the housing body enables the direction of force to be changed easily and, if appropriate, flexibly, so that the pulling and compression device connected to the hydraulic force amplifier can be used particularly easily in different, even narrow, environments, such as hard-to-reach areas of a motor vehicle.

According to an advantageous further development of the invention, it is provided that the housing body has a second working chamber filled with hydraulic fluid, the second working chamber being formed by two partial working chambers connected by a hydraulic coupling. The partial working chambers are separated from one another, in the longitudinal axis direction of the housing body, by the hydraulic pistons and/or the first working chamber, and are connected to one another via the hydraulic coupling, for example a line for the hydraulic fluid.

In a preferred embodiment, the first hydraulic piston has a third piston surface arranged at a distance from the first piston surface and the second hydraulic piston has a fourth piston surface arranged at a distance from the second piston surface, the third and fourth piston surfaces each being arranged in one of the partial working chambers of the second working chamber. The partial working chambers are delimited by the two hydraulic pistons, in particular the third piston surface or the fourth piston surface, and the inner wall of the housing body. The third piston surface is arranged facing away from the first piston surface on the first hydraulic piston. The fourth piston surface is arranged on the second hydraulic piston facing away from the second piston surface.

The piston surfaces of the two hydraulic pistons are each connected to one another via a support element, which defines the distance between the piston surfaces of a hydraulic piston. The second working chamber and the advantageous configuration of the hydraulic pistons enable a simple and reliable hydraulic return of the second hydraulic piston when the first hydraulic piston is adjusted from the end position to the starting position. In addition, this embodiment of the invention can counteract the risk of cavitation in the hydraulic fluid located in the first working chamber.

According to an advantageous further development of the invention, it is provided that the second working chamber is connected to a compensation volume for thermal equalization of the hydraulic fluid. The compensation volume is understood to be a container connected to the second working chamber, for example via a line. The compensation volume is designed to store some of the hydraulic fluid in the second working chamber in the event of thermal expansion and to release it back into the second working chamber. For example, the compensation volume has a third hydraulic piston. The third hydraulic piston is adjustable for receiving and/or dispensing of the hydraulic fluid within the compensation volume. The compensation volume has a spring element for pretensioning, in particular spring pretensioning, the third hydraulic piston in order to automatically dispense the hydraulic fluid stored in the compensation volume to the second working chamber.

According to an advantageous further development of the invention, it is provided that the tool connection has a quick coupling. The quick coupling describes a mechanical coupling of the tool connection, which is designed in such a way that pulling and pressing tools can be easily and quickly connected to the tool holder. For example, the quick coupling is in the form of a bayonet lock or a ball lock. The quick coupling enables the pulling and pressing tools that can be connected to the force amplifier to be changed easily and conveniently.

The invention further solves the object by a hand-held pulling and compression device for driving pulling and pressing tools, with
a drive unit comprising a battery-operated electric motor,
a screw drive with a threaded spindle connected to the drive unit and mounted rotatably on a housing body, and a threaded nut mounted rotatably on the threaded spindle and non-rotatably on the housing body via a bearing unit, and
a coupling unit connected to a tool holder for transmitting tensile and compressive forces resulting from the direction of rotation of the threaded spindle from the threaded nut to the tool holder, wherein
the pulling and compression device is detachably connected to a hydraulic force amplifier according to the invention or further developed as described above.

In addition to the drive of mechanically driven drawing and pressing tools with the maximum force generated via the pulling and pressing device, the hand-held pulling and pressing device according to the invention also enables the drive with forces exceeding this maximum force via the force amplifier, whereby, if necessary, it is possible to switch between an original drive via the pulling and pressing device and the amplified drive via the force amplifier in a simple manner by connecting or disconnecting the force amplifier to the pulling and pressing device.

### BRIEF DESCRIPTION OF THE DRAWINGS

An embodiment of the invention is explained below with reference to the drawings. The drawings show in:

FIG. 1 a perspective view of a schematic representation of a hydraulic force amplifier for a hand-held pulling and compression device;

FIG. 2a a sectional view of a schematic representation of the hydraulic force amplifier of FIG. 1 with a first hydraulic piston arranged in a starting position;

FIG. 2b a sectional view of a schematic representation of the hydraulic force amplifier of FIGS. 1 and 2a with the first hydraulic piston arranged in an end position;

FIG. 3 a perspective view of a schematic representation of a pulling and compression device with a hydraulic force amplifier arranged on it;

FIG. 4a a sectional view of a schematic representation of the pulling and compression device of FIG. 3 with the hydraulic force amplifier arranged thereon with the first hydraulic piston arranged in the starting position;

FIG. 4b a sectional view of a schematic representation of the pulling and compression device of FIGS. 3 and 4a with the hydraulic force amplifier arranged thereon with the first hydraulic piston arranged in the end position;

FIG. 5 a perspective view of a schematic representation of another embodiment of the hydraulic force amplifier.

### DETAILED DESCRIPTION

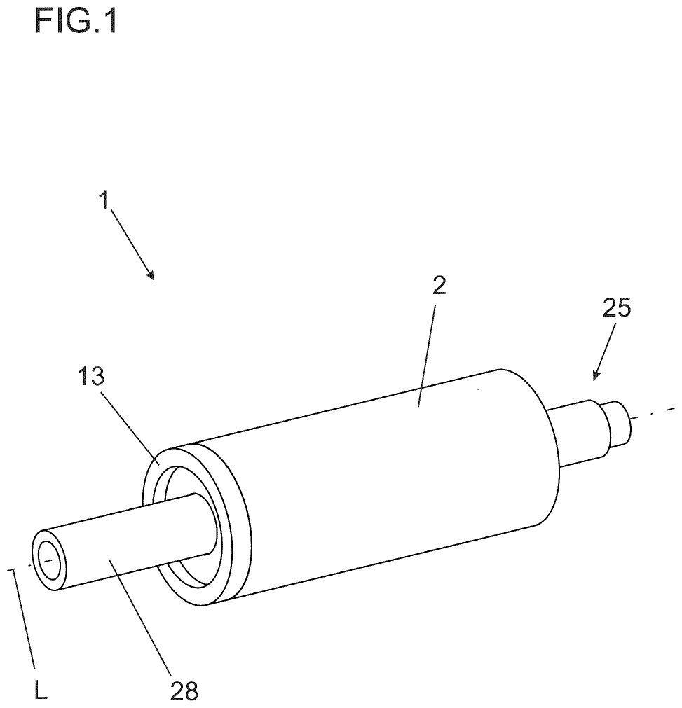

FIG. 1 shows a sectional view of an embodiment of a hydraulic force amplifier 1 with a housing body 2 and a cover 13 sealingly closing the housing body 2.

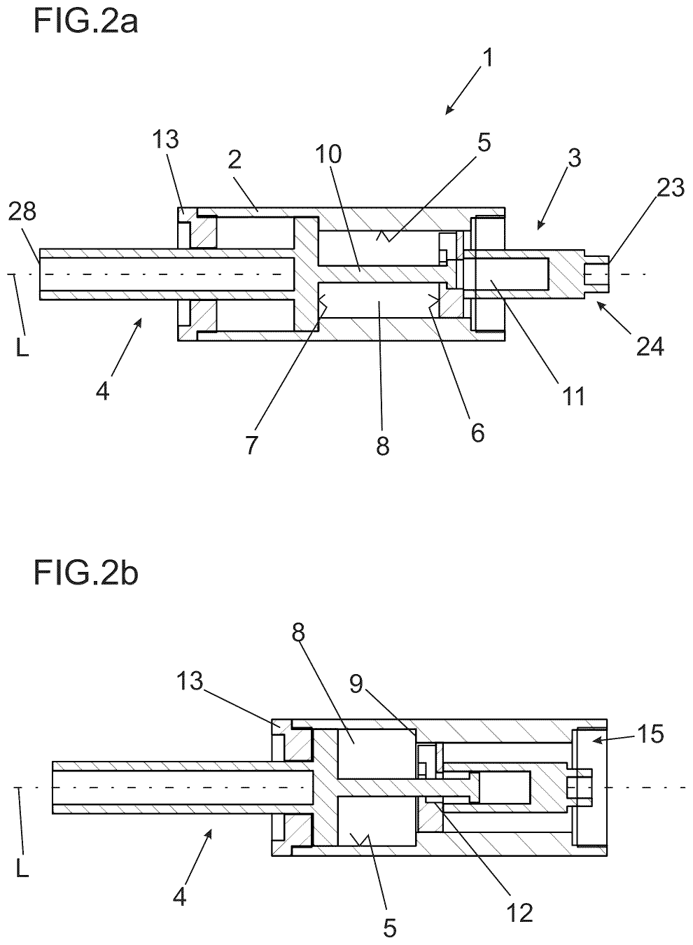

A first hydraulic piston 3, which can be adjusted between a starting position shown in FIG. 2a and an end position shown in FIG. 2b, and a second hydraulic piston 4 are arranged inside the housing body 2. An inner wall 5 of the housing body 2, together with a first piston surface 6 of the first hydraulic piston 3 and a second piston surface 7 of the second hydraulic piston 4 arranged at a distance from the first piston surface 6 and facing it, delimits a first working chamber 8, which is filled with hydraulic fluid. The second hydraulic piston 4 is adjustable within the housing body 2 between a starting state associated with the starting position, shown in FIG. 2a, and an end state associated with the end position, shown in FIG. 2b. Starting from the starting position shown in FIG. 2a, the first hydraulic piston 3 can be adjusted to the end position shown in FIG. 2b, whereby the pressure generated during the adjustment by the hydraulic fluid arranged in the working chamber 5 causes the second hydraulic piston 4 to be adjusted from the starting state, which in this position rests partially against a shoulder 9 of the base body 4 with the second piston surface 7 facing the working chamber 5, to the end state shown in FIG. 2b.

To return the second hydraulic piston 4 from the end state shown in FIG. 2b to the starting state shown in FIG. 2a, a connecting element 10 positively connecting the hydraulic pistons 3, 4 is used, which is arranged at one end on the second hydraulic piston 4 and at the other end is received in a receptacle arranged on the first hydraulic piston 3 and having the form of a cavity 11. When the first hydraulic piston 3 is adjusted from the end position to the starting position, the connecting element 10 rests against an inner surface 12 of the cavity 11, so that when the first hydraulic piston 3 is returned from the end position to the starting position, a positive fit is formed between the hydraulic pistons 3, 4 in the direction of a longitudinal axis L of the housing body. Via a tool connection 28, the second hydraulic piston 4 can be mechanically connected to a pulling and pressing tool not shown, so that the tensile and compressive forces increased by the force amplifier 1 are transmitted to the pulling and pressing tool.

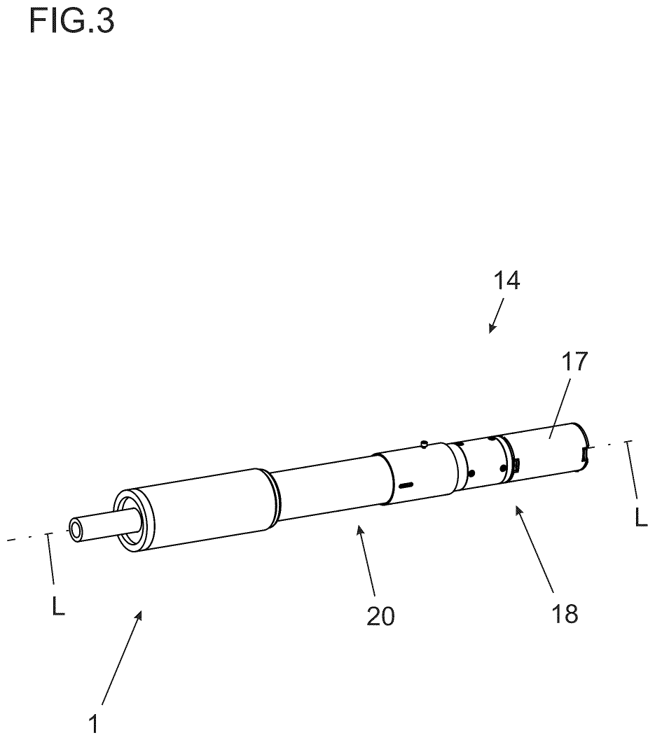

To connect the force amplifier 1 to a pulling and compression device 14 shown in FIG. 3, the housing body 2 has a connecting section 15, which is designed for detachable connection to a connection section 16 of the pulling and compression device 14, so that the force amplifier 1 can be arranged in a fixed position on the pulling and compression device 14.

The pulling and compression device 14 has a drive unit 18 comprising an electric motor 17, by which a threaded spindle 19 of a screw drive 20 arranged in a housing body 27 can be driven. In addition to the threaded spindle 19, the screw drive 20 also has a threaded nut 21 arranged on the threaded spindle 19, which threaded nut 21 is mounted non-rotatably on the housing body 27. The threaded nut 21 is used to drive a tool holder in the form of a piston rod 22, which is mounted so as to be adjustable in the longitudinal axis direction of the threaded spindle 19, so that the first hydraulic piston 3 can be adjusted in the direction of the force amplifier 1 by the pulling and compression device 14 via the piston rod 22 as a drive element. The first hydraulic piston 3 has a coupling section 24 on an end face 23 facing the piston rod 22, so that movements of the piston rod 22 are reliably transmitted to the first hydraulic piston 6. The piston rod 22 is connected to the threaded nut 21 via a detachable coupling unit 25, which rests against an end face 26 of the threaded nut 21 facing away from the piston rod 22 at its end opposite the piston rod 22. A bearing unit 38, which is attached to the coupling unit 25, serves for non-rotatable mounting of the threaded nut 21 on the housing body 27.

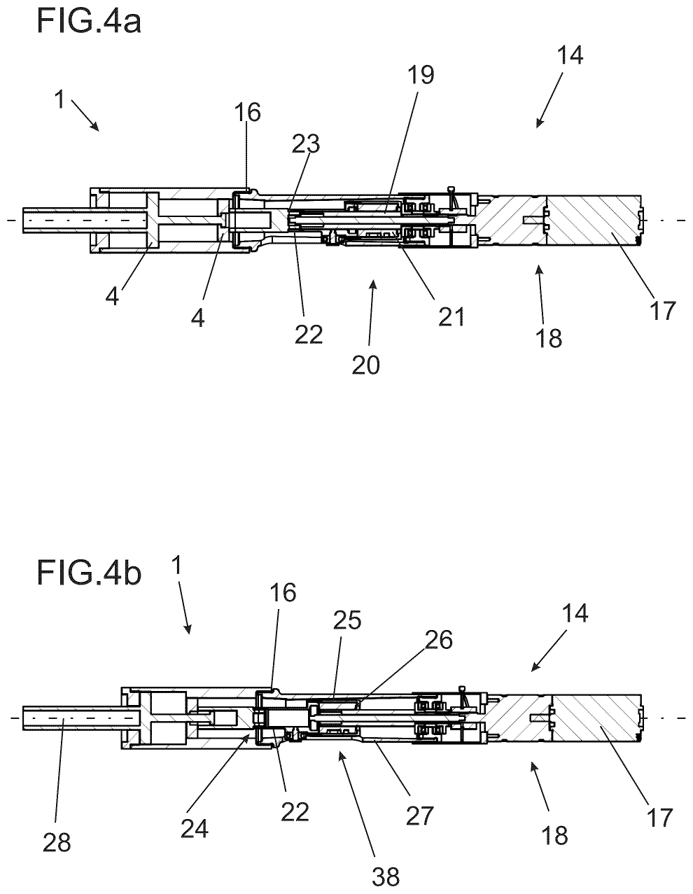

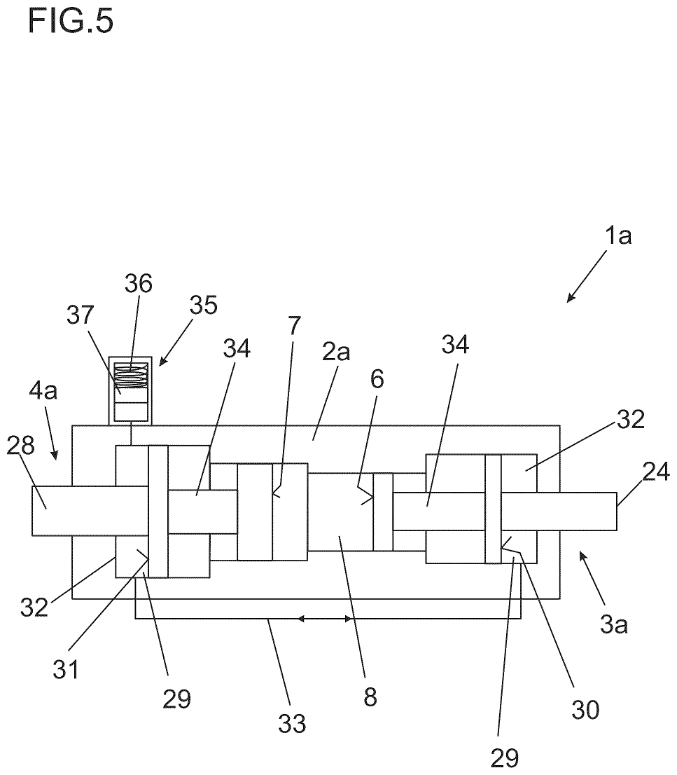

For the hydraulic force amplifier 1a shown in FIG. 5, which represents a further embodiment of the hydraulic force amplifier 1, the same reference symbols are used for the same components. The hydraulic force amplifier 1a differs from the force amplifier according to FIGS. 1 to 4b by the missing connecting element 15, a second working chamber 29 and an alternative design of the hydraulic pistons 3a, 4a. The first hydraulic piston 3a has a third piston surface 30 arranged at a distance from the first piston surface 6 and the second hydraulic piston 7 has a fourth piston surface 31 arranged at a distance from the second piston surface 7. The second working chamber 29 is formed by two partial working chambers 32, which are each delimited by the third piston surface 30 or the fourth piston surface 31, and the inner wall 5 of the housing body 2a. The partial working chambers 32 are separated from one another in the longitudinal axis direction of the housing body 2a by the hydraulic pistons 3a, 4a and the first working chamber 8 and are connected to one another via a hydraulic coupling in the form of a line 33 for the hydraulic fluid.

In addition, the piston surfaces 6, 7, 30, 31 of the two hydraulic pistons 3a, 4a are each connected to each other via a support element 34 defining the distance between the piston surfaces 6, 7, 30, 3 of a hydraulic piston 3a, 4a. The second working chamber 29 is also connected to a compensation volume 35 for thermal compensation of the hydraulic fluid. The compensation volume 35 has a spring element 36 for spring pretensioning a third hydraulic piston 37 arranged on the compensation volume 35.

The hydraulic force amplifier 1 enables pulling and pressing tools to be driven with increased pressing force in a simple and reliable manner by the hand-held pulling and compression device 14, so that the pulling and compression device 14 can be used flexibly for various operations.

All the features explained in connection with individual embodiments of the invention may be provided in different combinations for the hydraulic force amplifier or the hand-held pulling and compression device in order to realize their advantageous effects, even if these have been described for different embodiments.

### LIST OF REFERENCE SYMBOLS

1 Hydraulic force amplifier
2 Housing body
3 First hydraulic piston
4 Second hydraulic piston
5 Inner wall
6 First piston surface
7 Second piston surface
8 First working chamber
9 Shoulder
10 Connecting element
11 Receptacle (cavity)
12 Inner surface
13 Cover
14 Pulling/compression device
15 Connecting section
16 Connection section (pulling and compression device)
17 Electric motor
18 Drive unit
19 Threaded spindle
20 Screw drive
21 Threaded nut
22 Piston rod; tool holder (drive element)
23 End face (first hydraulic piston)
24 Coupling section (first hydraulic piston)
25 Coupling unit
26 End face (coupling unit)
27 Housing body (pulling and compression device)
28 Tool connection
29 Second working chamber
30 Third piston surface
31 Fourth piston surface
32 Partial working chamber
33 Hydraulic coupling (line)
34 Support element
35 Compensation volume
36 Spring element
37 Third hydraulic piston
L Longitudinal axis of the housing body (force amplifier)

1. Hydraulic force amplifier for an electro-mechanical driven pulling and compression device for driving pulling and pressing tools, with
a housing body having at least one first working chamber filled with hydraulic fluid, with a connecting section for detachable fixing of the force amplifier to a connection section of the pulling and compression device,
a first hydraulic piston displaceably arranged in the first working chamber between a starting position and an end position, comprising
a first piston surface and
a coupling section for connection to a drive element of the pulling and compression device which is adjustable relative to the connection section, and
a second hydraulic piston displaceably arranged in the first working chamber at a distance from the first hydraulic piston, comprising
a second piston surface which is larger than the first piston surface, and
a mechanical tool connection for pulling and pressing tools.

2. Hydraulic force amplifier according to claim 1, wherein the second hydraulic piston is positively connected to the first hydraulic piston via a connecting element.

3. Hydraulic force amplifier according to claim 1, wherein the first hydraulic piston has a receptacle for arranging the connecting element.

4. Hydraulic force amplifier according to claim 1, wherein the coupling section is designed for connection to a drive element of the pulling and compression device designed as a tool holder.

5. Hydraulic force amplifier according to claim 1, wherein the connecting section has a thread or latching body for detachable fixing to the connection section of the pulling and compression device having a thread or latching body receptacles.

6. Hydraulic force amplifier according to claim 1, wherein the hydraulic pistons can be arranged at an angle to one another.

7. Hydraulic force amplifier according to claim 1, wherein the housing body has a second working chamber filled with hydraulic fluid, wherein the second working chamber is formed by two partial working chambers connected by means of a hydraulic coupling.

8. Hydraulic force amplifier according to claim 1, wherein the first hydraulic piston has a third piston surface arranged at a distance from the first piston surface and the second hydraulic piston has a fourth piston surface arranged at a distance from the second piston surface, the third and fourth piston surfaces each being arranged in one of the partial working chambers of the second working chamber.

9. Hydraulic force amplifier according to claim 1, wherein the second working chamber is connected to a compensation volume for thermal compensation of the hydraulic fluid.

10. Hydraulic force amplifier according to claim 1, wherein the tool connection has a quick coupling.

11. Hand-held pulling and compression device for driving pulling and pressing tools, with
a drive unit comprising a battery-operated electric motor,
a screw drive with a threaded spindle connected to the drive unit and mounted rotatably on a housing body and a threaded nut mounted rotatably on the threaded spindle and non-rotatably on the housing body via a bearing unit, and
a coupling unit connected to a tool holder for transmitting tensile and compressive forces resulting from the direction of rotation of the threaded spindle from the threaded nut to the tool holder, including a hydraulic force amplifier detachably connected to the pulling and compression device according to claim 1.

12. Hydraulic force amplifier according to claim 2, wherein the first hydraulic piston has a receptacle for arranging the connecting element.

13. Hydraulic force amplifier according to claim 2, wherein the coupling section is designed for connection to a drive element of the pulling and compression device designed as a tool holder.

14. Hydraulic force amplifier according to claim 3, wherein the coupling section is designed for connection to a drive element of the pulling and compression device designed as a tool holder.

15. Hydraulic force amplifier according to claim 2, wherein the connecting section has a thread or latching body for detachable fixing to the connection section of the pulling and compression device having a thread or latching body receptacles.

16. Hydraulic force amplifier according to claim 3, wherein the connecting section has a thread or latching body for detachable fixing to the connection section of the pulling and compression device having a thread or latching body receptacles.

17. Hydraulic force amplifier according to claim 4, wherein the connecting section has a thread or latching body for detachable fixing to the connection section of the pulling and compression device having a thread or latching body receptacles.

18. Hydraulic force amplifier according to claim 2, wherein the housing body has a second working chamber filled with hydraulic fluid, wherein the second working chamber is formed by two partial working chambers connected a hydraulic coupling.

19. Hydraulic force amplifier according to claim 2, wherein the first hydraulic piston has a third piston surface arranged at a distance from the first piston surface and the second hydraulic piston has a fourth piston surface arranged at a distance from the second piston surface, the third and fourth piston surfaces each being arranged in one of the partial working chambers of the second working chamber.

20. Hydraulic force amplifier according to claim 2, wherein the second working chamber is connected to a compensation volume for thermal compensation of the hydraulic fluid.
